(19) United States
(12) Patent Application Publication
(10) Pub. No.: US 2006/0294394 A1
(43) Pub. Date: Dec. 28, 2006

(54) Fingerprint information acquisition device used in handheld device having built-in camera module

(75) Inventors: Chia-Chu Cheng, Hsin-Tien City (TW); Ming-Ho Wang, Hsin-Tien City (TW)

Correspondence Address: BIRCH STEWART KOLASCH & BIRCH, PO BOX 747, FALLS CHURCH, VA, 22040-0747, US

(73) Assignee: LITE-ON SEMICONDUCTOR CORP.

(21) Appl. No.: 11/436,608

(22) Filed: May 19, 2006

(30) Foreign Application Priority Data
Jun. 22, 2005 (TW) 94120765

(51) Int. Cl. H04K 1/00

(52) U.S. Cl. 713/186

(57) ABSTRACT

A fingerprint information acquisition device used in a handheld device having a built-in camera module includes a fingerprint information sensor array module, an A/D converter module and an I/O interface module, wherein the fingerprint information acquisition device can receive a command from the handheld device through a fingerprint information acquisition device serial control signal set which is electrically connected to a camera module serial control signal set by a transmission interface compatible to that between the built-in camera module and the handheld device and can transmit at least a fingerprint information to the handheld device through a fingerprint information acquisition device data transmission signal set which is electrically connected to a camera module data transmission signal set, thereby reducing the complexity in integrating the fingerprint information acquisition device into the handheld device.

### BACKGROUND OF THE INVENTION

1. Field of the Invention

The present invention is related to a fingerprint information acquisition device used in a handheld device having a built-in camera module, and more particularly to a fingerprint information acquisition device utilizing the built-in camera module and the given data transmission interface of the handheld device to transmit a fingerprint information to the handheld device.

2. Description of Related Art

Recently, owing to the rapid changing in semiconductor technology, handheld electronic devices become more and more popular in daily life, and because of the rapid development of digital information technology and the population of computer and network communication, integrating the personal identification system into the digital identify authentication in computer, Internet, cell phone, personnel in/out control, transportation, e-business, credit card, cash card and medical recording has become a current trend.

Furthermore, fingerprint comparison has become more and more important in identity recognition, and the fingerprint comparison via algorithm can complete a large amount of identity authentications in an extremely short time. Please refer to FIG. 1 which is a functional block diagram showing a fingerprint information acquisition device used in the conventional mid-end/high-end phone or smart phone having a built-in camera module and a fingerprint information collecting module. As shown in FIG. 1, the conventional handheld device having the built-in camera module such as mid-end/high-end phone or smart phone includes a built-in camera module la, a data transmission interface 2a, a baseband microprocessor 3a, a fingerprint information collecting module 4a, a memory bus 5a, a serial peripheral interface (SPI) bus 6a, and a memory storage module 7a

The micro-camera module la is used to collect at least an image information. The data transmission interface 2a of the handheld device has a transmission protocol needed to receive the at least an image information, and the data transmission interface 2a has a serial control signal set 21a for making a command to and communicating the status thereof with the camera module 1a and a data transmission signal set 22a for receiving the image information from the cameral module. Therefore, the at least an image information is transmitted to the handheld device through the data transmission signal set 22a having the transmission protocol therein. Moreover, the baseband microprocessor 3a is electrically connected to the handheld device and the memory storage module 7a for performing the follow-up processing or application to the image information received by the handheld device.

Furthermore, in the conventional handheld device having the built-in camera module and the fingerprint information collecting module such as high-end phone or smart phone, the fingerprint information collecting module 4a is electrically connected to the baseband microprocessor 3a in parallel or serial through the memory bus 5a or the SPI bus 6a so that the fingerprint information collected by the fingerprint information collecting module 4a is transmitted to the baseband microprocessor 3a through the memory bus 5a or the SPI bus 6a for performing the follow-up image processing and other application.

Please refer to FIG. 2 which is a functional block diagram showing the conventional PDA or PDA phone having the built-in camera module and the fingerprint information collecting module. As shown in FIG. 2, the difference between the conventional PDA or PDA phone having the built-in camera module and the fingerprint information collecting module and the conventional high-end phone or smart phone is: a system processor 8 is used to replace the baseband microprocessor 3a.

However, although the conventional fingerprint information collecting module 4a utilizes the memory bus 5a or the serial peripheral interface bus 6a to transmit the fingerprint information to the baseband microprocessor 3a or the system processor 8a, the memory bus 5a is not conformable to the characteristic of image peripheral apparatus because it is designed to transmit data to the memory storage module 7a, and further, because the data transmission rate of the serial peripheral interface bus 6a is very slow, it is also not conformable to the demand. Besides, currently, because there is not a common protocol integrated between the fingerprint information collecting module 4a and the baseband microprocessor 3a or the system processor 8a, the system integration becomes more difficult and more complicated.

Accordingly, the integration between the above-described conventional fingerprint information collecting module 4a and the baseband microprocessor 3a or the system processor 8a obviously has inconvenience and imperfection and needs to be improved.

Consequently, because of the technical defects of described above, the applicant keeps on carving unflaggingly through wholehearted experience and research to develop the present invention, which can effectively improve the defects described above.

### SUMMARY OF THE INVENTION

The technical problem to be solved in the present invention is to provide a fingerprint information acquisition device used in a handheld device with a built-in camera module. In the present invention, the transmission interface of the fingerprint information acquisition device is designed to be a data transmission interface compatible to that between the built-in camera module and the handheld device such that the fingerprint information acquisition device can be easily integrated with the handheld device having the built-in cameral module thereby reducing the complexity in integrating the fingerprint information acquisition device into the handheld device.

For solving the problem described above, one proposal of the present invention is to provide a fingerprint information acquisition device used in a handheld device having a built-in camera module which at least includes a fingerprint information sensor array module, an A/D converter module and an I/O interface module.

The fingerprint information sensor array module is used to sense the concave and convex information of a fingerprint, the A/D converter module is used to convert an analog signal sensed by the fingerprint information sensor array module 1 into a digital signal, and the I/O interface module at least includes a major working clock input signal, a serial control signal set, a register table, a format conversion circuit and a data transmission signal set, wherein the major working clock input signal is used to receive a clock input signal provided by the handheld device, the serial control signal set is used to receive a command from the handheld device and to communicate with the fingerprint information acquisition device for identifying the status thereof, the register table is used to store each predetermined address and provide the handheld device parameter values for reading or modification, and the format conversion circuit is used to convert the digitalized fingerprint information into a format compatible to the transmission protocol between the handheld device and the built-in camera module thereby transmitting the formatted digital fingerprint information to the handheld device through the data transmission signal set.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a functional block diagram showing a fingerprint information acquisition device used in the conventional mid-end/high-end phone or smart phone having a built-in camera module and a fingerprint information collecting module;

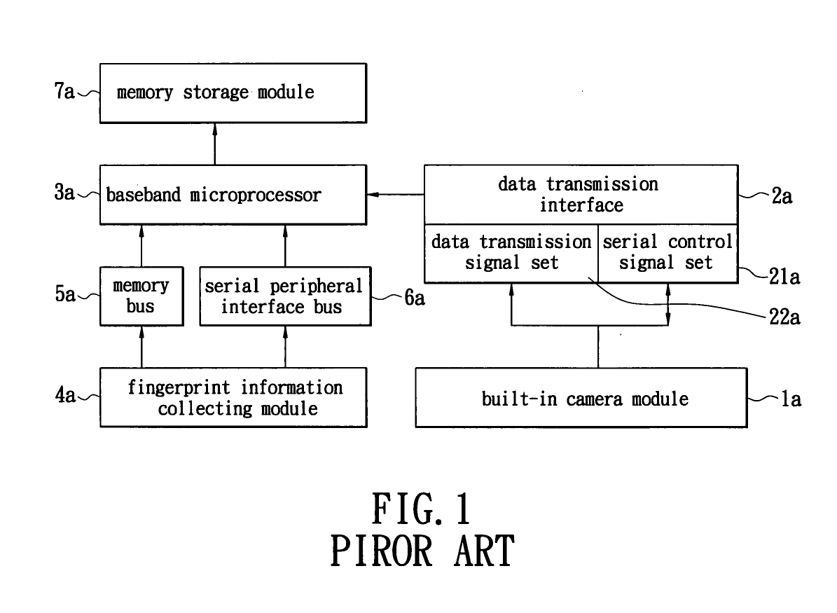

FIG. 2 is a functional block diagram showing a fingerprint information acquisition device used in the conventional PDA or PDA phone having a built-in camera module and a fingerprint information collecting module; and

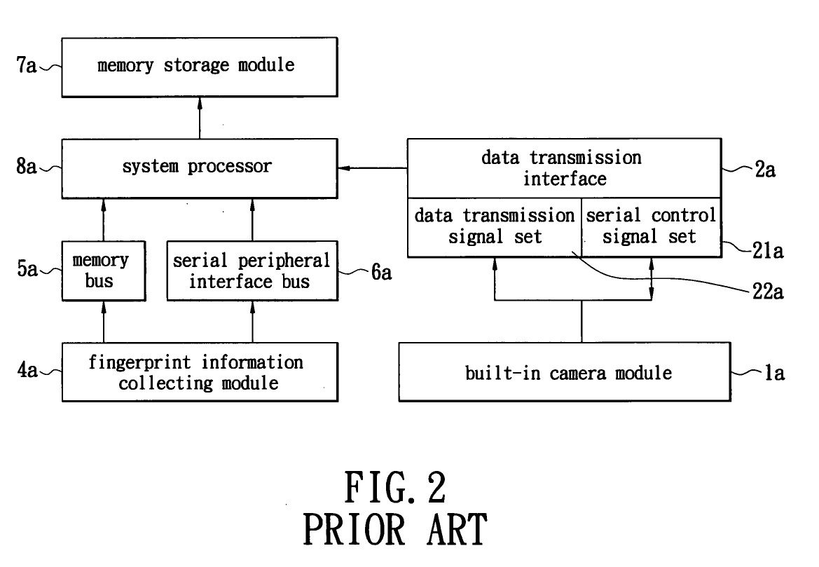

FIG. 3 is a functional block diagram showing a fingerprint information acquisition device used in a handheld device having a built-in

### DETAILED DESCRIPTION OF PREFERRED EMBODIMENTS

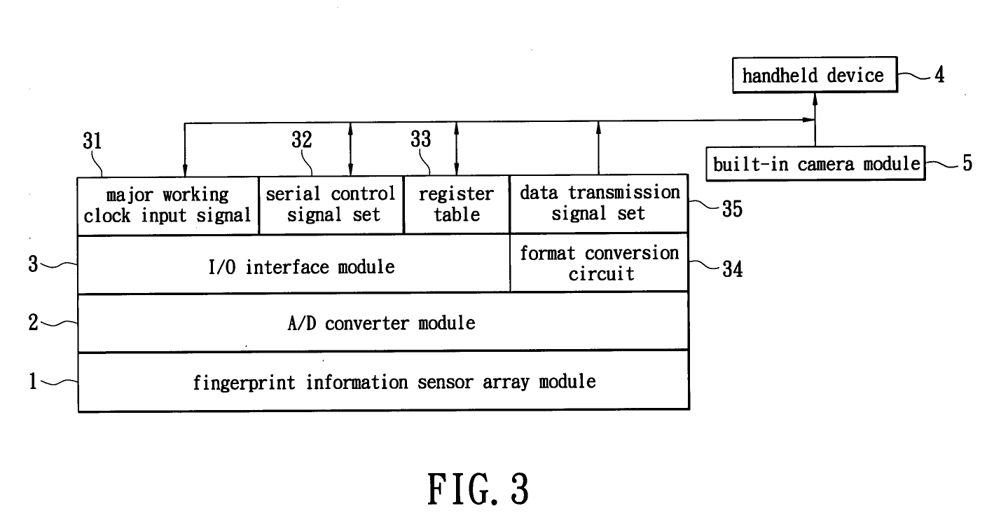

Please refer to FIG. 3 which is a functional block diagram showing a fingerprint information acquisition device used in a handheld device having a built-in camera module according to the present invention. As shown in FIG. 3, the present invention provides a fingerprint information acquisition device used in a handheld device having a built-in camera module which includes a fingerprint information sensor array module 1, an A/D converter module 2, and an I/O interface module 3.

The handheld device 4 can be a cell phone with a built-in camera module, a PDA with a built-in camera module, or any handheld or portable device with a built-in camera module. The fingerprint information sensor array module can be an area type, a linear type, or a band type fingerprint information sensor array module.

Moreover, the fingerprint information sensor array module 1 is used to sense the concave and convex information of a fingerprint. And, the A/D converter module 2 is used to convert an analog signal sensed by the fingerprint information sensor array module 1 into a digital signal

In addition, the I/O interface module 3 at least includes a major working clock input signal (MClk) 31, a serial control signal set 32, a register table 33, a format conversion circuit 34 and a data transmission signal set 35. The major working clock input signal (MClk) 31 is used to receive a clock input signal provided by the handheld device 4. The serial control signal set 32 is used to receive a command from the handheld device 4 and to communicate with the fingerprint information acquisition device for identifying the status thereof. The register table 33 is used to store each predetermined address and provide the handheld device parameter values for reading or modification, wherein the register table at least includes an identifier for identifying the fingerprint information acquisition device so as to make the handheld device 4 to identify the fingerprint information acquisition device and also make a command or a status communication and receive data. The format conversion circuit 34 is used to convert the digitalized fingerprint information into a format compatible to the transmission protocol between the handheld device 4 and the built-in camera module 5 thereby transmitting the formatted digital fingerprint information to the handheld device 4 through the data transmission signal set 35.

That is to say, firstly, the handheld device 4 uses the serial control signal set 32 to make a command to the fingerprint information acquisition device for identifying, in the register table 33, the identifier of the fingerprint information acquisition device. After identifying that it is correct, the handheld device 4 can continuously command the register table 33 the follow-up commands or communicate and identify the status thereof via the serial control signal set 32. When the fingerprint information acquisition device has collected at least an analog fingerprint information via the fingerprint information sensor array module 1 and has converted the analog fingerprint information into a digital form, the format of the I/O interface module 3 will be converted in accordance with the commands and the communication and identification results from the handheld device 4 which are stored and recorded in the register table 33. The I/O interface module 3 may notify the handheld device 4 through the serial control signal set 35 such that the handheld device 4 can receive the formatted digital fingerprint information through the data transmission signal set 35, or the handheld device 4 can inform the fingerprint information acquisition device through the serial control signal set 32 such that the fingerprint information acquisition device can transmit the formatted digital fingerprint information to the handheld device 4 through the data transmission signal set 35 so as to perform relative image processes.

The serial control signal set 32 includes: at least a serial data line (SDA) and a serial clock line (SCL). One embodiment for the data transmission signal set includes a differential data signal line pair, data+ and data−, and a different clock signal line pair, Clk+ and Clk−. Another embodiment for the data transmission signal set includes a fingerprint signal output clock, a horizontal synchronous signal (Hsync), a vertical synchronous signal (Vsync) and a set of fingerprint signal parallel output buses.

That is to say, the fingerprint information acquisition device is electrically connected to the handheld device 4 and may transmit at least a fingerprint information to the handheld device 4 via the data transmission interface by the data format which is compatible to the transmission protocol between the built-in camera module 5 and the handheld device 4. Furthermore, the fingerprint data acquisition device can transmit the fingerprint data to the handheld device 4 through the given data transmission interface and the transmission protocol thereof between the built-in cameral 5 and the handheld device 4. In a word, without redesigning or modifying the transmission interface and transmission protocol thereof between the built-in cameral 5 and the handheld device 4, the user still can receive the fingerprint image collected by the fingerprint information acquisition device through the given integrated data transmission interface and the transmission protocol thereof and the identification of the identifiers at both sides.

In the aforesaid, the present invention adopts an indirect manner to design the transmission interface of the fingerprint information acquisition device to be an interface analogous to that between the built-in camera module 5 and the handheld device 4 such that the fingerprint information acquisition device can be easily integrated with the handheld device 4 having the built-in cameral module 5 thereby reducing the complexity in integrating the fingerprint information acquisition device into the handheld device 4.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fingerprint information acquisition device used in a handheld device having a built-in camera module, at least comprising:
a fingerprint information sensor array module for sensing the concave and convex information of a fingerprint;
an A/D converter module for converting a fingerprint information sensed by the fingerprint information sensor array module from an analog signal into a digital signal; and
an I/O interface module at least comprising a major working clock input signal, a serial control signal set, a format conversion circuit, a register table and a data transmission signal set, wherein the major working clock input signal is used to receive a clock input signal provided by the handheld device, the serial control signal set is used to receive a command from the handheld device and communicate with the fingerprint information acquisition device for identifying a status thereof, the register table is used to store each predetermined address and provide the handheld device a parameter value for reading or modification, and the format conversion circuit is used to convert the digitalized fingerprint information into a format compatible to a transmission protocol between the handheld device and the built-in camera module, thereby transmitting the formatted digital fingerprint information to the handheld device through the data transmission signal set.

2. The device as claimed in claim 1, wherein the register table at least comprises an identifier for identifying the fingerprint information acquisition device so as to make the handheld device to identify the fingerprint information acquisition device and also make a command or a status communication and receive data.

3. The device as claimed in claim 1, wherein the serial control signal set comprises at least a serial data line (SDA) and a serial clock line (SCL).

4. The device as claimed in claim 1, wherein the data transmission signal set comprises a differential data signal line pair, data+ and data−, and a different clock signal line pair, Clk+ and Clk−.

5. The device as claimed in claim 1, wherein the data transmission signal set comprises a fingerprint signal output clock, a horizontal synchronous signal, a vertical synchronous signal and a parallel output bus.

6. The device as claimed in claim 1, wherein the fingerprint information sensor array module is an area type fingerprint information sensor array module.

7. The device as claimed in claim 1, wherein the fingerprint information sensor array module is a linear type fingerprint information sensor array module.

8. The device as claimed in claim 1, wherein the fingerprint information sensor array module is a band type fingerprint information sensor array module.

9. The device as claimed in claim 1, wherein the handheld device is a cell phone or a PDA (personal digital assistant).
